(19) United States
(12) Patent Application Publication
(10) Pub. No.: US 2025/0236243 A1
(43) Pub. Date: Jul. 24, 2025

(54) DEVICE AND SYSTEM FOR A MOTOR VEHICLE FOR LOCKING AND/OR UNLOCKING AN OBJECT

(71) Applicant: Volkswagen Aktiengesellschaft, Wolfsburg (DE)

(72) Inventors: André Schwaß, Braunschweig (DE); Dennis Sattelmaier, Gifhorn (DE); Roman Gabbert, Magdeburg (DE); Jörg Lederer, Braunschweig (DE)

(21) Appl. No.: 19/020,772

(22) Filed: Jan. 14, 2025

(30) Foreign Application Priority Data
Jan. 18, 2024 (DE) 102024200480.4

(51) Int. Cl. B60R 9/10; B60R 11/00; B62H 5/00

(52) U.S. Cl. CPC B60R 9/10; B62H 5/003; B60R 2011/008; B60R 2011/0098; B60R 2325/10

(57) ABSTRACT

A device and a system for a motor vehicle configured for locking and/or unlocking an object. The device includes a lock, a communication unit configured to send and receive radio signals, and a control unit. The device is operable via radio communication with the motor vehicle's central locking system and can be coupled to the motor vehicle in a manner allowing substantial freedom in selecting its position relative to the motor vehicle. The system further enables objects, such as bicycles or other items, to be secured to the motor vehicle without requiring separate access devices.

### RELATED APPLICATIONS

The present application claims priority to German Patent Application No. 102024200480.4 filed Jan. 18, 2024, to André Schwaβ, the contents of which are incorporated by reference in its entirety herein.

### TECHNICAL FIELD

The present disclosure relates to a device and to a system comprising the device for a motor vehicle for locking and/or unlocking an object.

### BACKGROUND

Objects in the passenger compartment of motor vehicles can usually be easily protected against theft by operating the central locking system of the motor vehicle. For this purpose, the central locking system is simply activated to lock the door lock systems of the motor vehicle.

Objects accessible from the outside or located outside the motor vehicle, in contrast, frequently must be separately protected against theft. For this purpose, conventional locking systems using dedicated access devices, such as keys or transponders, can be used effectively.

A clamping system for a bicycle for attachment to an attachment module of a vehicle is known from document DE 10 2018 219 166 B4. The clamping system comprises a mount including a pair of legs that are arranged to be movable relative to one another, which are pretensioned by a force to prevent spreading and maintain the bicycle in an offloaded and parked state. The pretension is effectuated by an activated electromechanical control element, establishing a force-fit connection between the bicycle and the legs.

A roof rack system for a motor vehicle is known from document DE 10 2014 106 473 B4. The roof rack system comprises a base carrier device for connecting the roof rack system to a motor vehicle roof, a carrier device for connecting objects to be transported to the roof rack system, and at least one coupling device for coupling the carrier device to the base carrier device. In one example, the base carrier device is connected to a central locking system to likewise lock the device when the motor vehicle is locked.

The issue with existing locking systems is that either a separate key or transponder for opening and locking the system must be carried, or the usability of the locking systems is limited to a specific object type to be protected against theft. Examples include bicycle racks, which primarily protect bicycles, or roof luggage racks, which only protect objects stowed on the vehicle roof.

### SUMMARY

Aspects of the present disclosure are directed to providing a multifaceted and user-friendly option for a motor vehicle for locking and/or unlocking an object.

Aspects of the present disclosure are described in the independent claims, and further aspects are described in the dependent claims, where advantageous refinements and enhancements are detailed.

A first aspect relates to a device for a motor vehicle for locking and/or unlocking an object (or a plurality thereof), for example, an object that is movable in relation to the motor vehicle, preferably an object that is accessible from the outside or located outside the motor vehicle. The device comprises a lock, a communication unit configured to send and receive radio signals, and a control unit.

The communication unit is configured to receive a radio signal, which includes a locking request or an unlocking request from a user of a central locking system of the motor vehicle, via a vehicle communication unit. In this manner, the device is integrated into the central locking circuit of the motor vehicle, enabling operation via the central locking system of the motor vehicle.

In some examples, the control unit is configured to lock and/or unlock the lock based on the received radio signal. This means that the lock of the device can be operated by the user via the central locking system of the motor vehicle, such as through a wireless remote control that communicates with the central locking system. This eliminates the need for separately carried access devices, such as keys or transponders, which are required for conventional locking systems. According to the present disclosure, no additional locking of the lock is necessary beyond the locking of the door lock systems through the central locking system.

A person skilled in the art will understand that the functionalities of multiple computers (data processing devices) can be combined into a single device, or distributed among multiple devices, to carry out the disclosed methods and systems.

Further preferred embodiments of the present disclosure are derived from the additional features described in the dependent claims.

The various embodiments described in the present application can advantageously be combined with one another, unless indicated otherwise in a specific instance.

### BRIEF DESCRIPTION OF THE DRAWINGS

The present disclosure will be described hereafter in exemplary embodiments based on the associated drawing. In the drawing:

FIG. 1 shows a schematic representation of a system comprising a device for a motor vehicle for locking and/or unlocking an object according to some aspects of the present disclosure.

### DETAILED DESCRIPTION

In some examples, the device described herein may be configured to be couplable, for example mechanically connectable, to the motor vehicle in a manner that is variable in terms of the position in relation to the motor vehicle by locking of the lock. In other words, the locked position of the device relative to the motor vehicle can be varied. The device can thus be used or placed substantially mechanically independently of a connecting position predefined by the motor vehicle. For example, the device comprises one or more arms that are connected, or can be connected, to the lock and that are configured to couple the object to the motor vehicle by surrounding or being guided through an opening of the object. The user can consequently decide the location at which the device according to the present disclosure is positioned at the motor vehicle and where the object or objects are to be locked so as to protect these against theft. For example, the lock used for securing an object can be unlocked at the same time as the motor vehicle is opened by way of the central locking system, for example by way of the wireless remote control of the motor vehicle. When the motor vehicle is locked again, for example by way of the wireless remote control, the object is also automatically locked and is thus automatically secured against theft.

In some examples, the device is furthermore configured to be decouplable from the motor vehicle, for example removable from the motor vehicle, by unlocking of the lock. In other words, the user can unlock the lock of the device and thereby remove the device from the motor vehicle. Thereafter, the user can use the device, for example, at another location at the motor vehicle and/or for another object. The device can thus be used in a multifaceted manner and is therefore especially user-friendly.

In some examples, the device is configured to be couplable to the motor vehicle in a manner that is variable in terms of the position in relation to the motor vehicle in at least a plurality of locking positions, for example at least three different locking positions, preferably at least five different locking positions, or particularly preferably substantially continuously, by locking of the lock. This enables a multifaceted and user-friendly use of the device. It is likewise preferred when the device is configured in such a way that a position spacing of at least 10 cm, for example at least 25 cm, preferably at least 50 cm exists between the locking positions of the plurality of locking positions.

In some examples, the device furthermore comprises a function for varying the coupling surface between the device and the motor vehicle and/or the object. For example, the function is effectuated by means of releasable teeth in the manner of a cable tie. The arms that are connected, or can be connected, to the lock preferably comprise the releasable teeth in the manner of a cable tie by way of which the effective arm length can be matched to the object to be locked. As a result, the object cannot just be locked, but also be fixed to the motor vehicle so as to prevent it from rattling or falling out.

In some examples, the device is configured to be coupled to the motor vehicle so as to be movable with respect to the motor vehicle in a locked state of the lock. In other words, the device is not statically coupled to the motor vehicle in the locked state. Consequently, the device does not require any fixedly predefined connector or plug for the coupling to the motor vehicle, but can generally be freely positioned at the object and/or at the motor vehicle.

In some examples, the device is designed as a U-lock, a folding lock, a chain lock, a cable lock, or a textile lock. The cable lock is preferably a steel cable lock or a steel wire lock. The aforementioned lock categories have in common that locking of the object is achieved by way of a connection of one or more arms to a mechanically self-contained circuit. The arm is or the arms are then connected to the lock. The arm or arms can, for example, comprise a rigid or movable bracket or rigid or movable links.

In some examples, it is provided that the communication unit is configured to send and receive UHF radio signals, and that the received radio signal is a UHF radio signal. The ultra-high frequency (UHF) band is in the range of 300 MHz to 3 GHz. Particularly preferably, a frequency between 433 and 434 MHz and/or 315 MHz is used for the radio signal transmission. The radio communication between wireless remote controls and motor vehicles frequently takes place in the aforementioned UHF frequency band so that the device can be easily integrated into the central locking system of existing motor vehicles.

In some examples, the motor vehicle furthermore comprises a mount for receiving a bicycle (bicycle rack), and the device is designed as a bicycle lock or the device is designed as a wheel boot. The lock that is used for securing a bicycle on the bicycle rack can thus be unlocked at the same time as the vehicle is opened. When the vehicle is locked again by way of the wireless remote control, the bicycle on the bicycle rack is also automatically locked and is thus secured against theft. The same principle applies to the wheel boot. A wheel boot is a mechanical immobilizer for the motor vehicle, which is also referred to as a parking boot, a wheel clamp or a Denver boot.

Another aspect of the present disclosure relates to a system for a motor vehicle for locking and/or unlocking an object comprising a device of the above-described type, wherein the central locking system of the motor vehicle can be controlled by way of a wireless remote control. The motor vehicle is preferably the above-described motor vehicle. The advantages achieved by way of the device can be achieved by way of the system in an analogous fashion. The disclosed feature combinations of the device can be analogously applied to the system. A repetition of the description of the features and advantages is therefore dispensed with.

In some examples, the wireless remote control comprises a separate function for locking and/or unlocking the device according to any one of the preceding claims. In other words, it is possible, by operating the wireless remote control, to operate the device individually, independently of the door lock systems of the motor vehicle that are connected to the central locking system. This prevents the doors from being unlocked when the user only desires to unlock the object locked by way of the device. In the case of a bicycle lock or a wheel boot, this prevents the user from (inadvertently) unlocking the vehicle doors in a situation in which the user's view of the vehicle doors is at least partly obstructed.

The wireless remote control is preferably configured to be operable by means of a button, a button combination and/or a gesture control function for locking and/or unlocking the device. In other words, the wireless remote control can comprise a dedicated or separate button for operating the device and/or a predefined button combination or gesture control function (stored in a memory unit) necessary for operating the device. For example, a button press duration and/or consecutive multiple operation of a button can be used for distinction. The wireless remote control furthermore preferably comprises motion sensors, such as acceleration sensors, gyroscopes and the like, which are configured to ascertain translatory and/or rotatory movement gestures.

The individual components of the control unit are preferably designed as one or more processes, which run on one or more processors in one or more electronic processing devices and are generated, during execution, by one or more computer programs. The processing devices are preferably designed to cooperate with other components, for example a communication unit configured to send and receive radio signals, so as to implement the functionalities described herein. The instructions of the computer programs are preferably likewise stored in a memory, such as a RAM element. However, the computer programs can also be stored in a non-volatile memory medium, such as a CD-ROM, a Flash memory or the like.

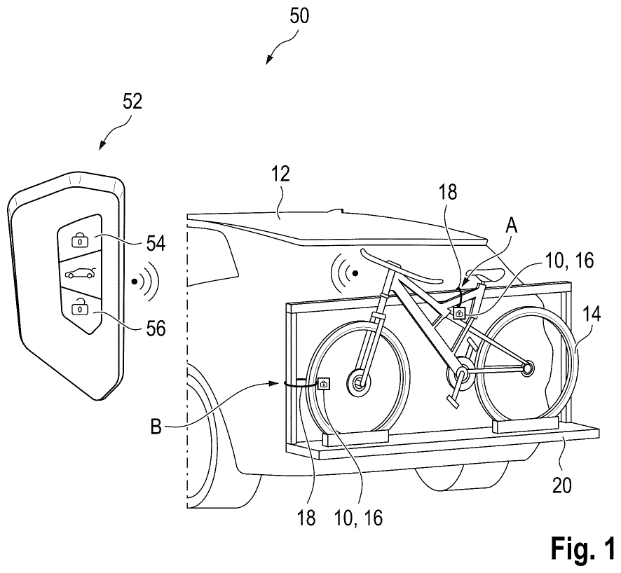

FIG. 1 shows a schematic representation of a system 50 comprising a device 10 for a motor vehicle 12 for locking and/or unlocking an object 14 according to one embodiment, which, by way of example, is configured as a bicycle, and a wireless remote control 52.

The device 10 comprises a lock 16, a communication unit (not shown in greater detail) configured to send and receive radio signals, and a control unit (not shown in greater detail).

The motor vehicle 12 comprises a vehicle communication unit (not shown in greater detail), a central locking system (not shown in greater detail) connected to the vehicle communication unit for activating the door lock systems of the motor vehicle 12 for locking and/or unlocking the motor vehicle 12, and a mount 18 for receiving the bicycle 14 at the rear of the motor vehicle 12.

The wireless remote control 52 comprises a remote-control communication unit (not shown in greater detail), a locking button 54, an unlocking button 56, and a button that is not specified in greater detail. The remote-control communication unit is configured to exchange radio communication signals with the vehicle communication unit, for example on a frequency band between 433 and 434 MHz, and in particular to transmit a locking request or an unlocking request of a user according to the push of the locking or unlocking button 54, 56 by means of a radio signal to the vehicle communication unit. Based on the received radio signal including the locking or unlocking request of the user, the central locking system of the motor vehicle 12 activates the door lock systems of the motor vehicle 12. According to the present disclosure, it is also provided that the locking or unlocking request of the user is furthermore transmitted from the vehicle communication system by means of radio signal to the communication unit of the device 10, for example likewise on the frequency band between 433 and 434 MHz. Accordingly, the communication unit of the device 10 is configured to receive the radio signal, which includes the locking or unlocking request of the user of the central locking system of the motor vehicle (12), from the vehicle communication unit.

The control unit of the device 10 is configured to lock and/or unlock the lock 16 based on the received radio signal. Consequently, the bicycle 14 situated in the mount 18 can be locked by a push of the locking button 54 of the wireless remote control 52 or can be unlocked for removal by a push of the unlocking button 56 of the wireless remote control 52. No additional locking or unlocking of the lock 16 is thus needed, aside from locking the door lock systems by way of the central locking system.

Moreover, the device 10 is configured to be couplable, for example mechanically connectable, to the motor vehicle 12 in a manner that is variable in terms of the position in relation to the motor vehicle 12 by a locking of the lock 16. This is shown by way of example in FIG. 1 based on the two locking positions A and B. In the first locking position A, the device 10 is located above the bicycle 14 and connects the handlebar of the bicycle 14 to the mount 18 of the motor vehicle 12. In the second locking position B, the device 10, for example, is arranged at the front wheel of the bicycle 14 and at a lateral support of the mount 18. In addition to the shown locking positions A and B, a plurality of further locking positions can, of course, be provided or possible.

Due to the fact that the locking positions A, B of the device 10 relative to the motor vehicle 12 can generally be varied, the user can freely decide (within the possible scope) the location at which they would like to position the device 10 at the motor vehicle 12 and where the bicycle 14 is to be locked so as to protect the same against theft. The variability of the locking positions A, B furthermore also allows objects 14 that differ from the bicycle 14, for example a wheel boot or other cargo, for example, cargo stowed on the vehicle roof, to be locked or unlocked by way of the device 10 via the operation of the wireless remote control 52. Consequently, multifaceted objects 14 can be protected against theft by way of the device 10.

In the shown example, the device 10 comprises an arm that is connected to the lock 16 and that is configured to guide the object 14 through an opening of the object 14, and through an opening of the mount 18 of the motor vehicle 12, so as to mechanically couple the object 14 to the mount 18 of the motor vehicle 12 in the locked state. In the locked state, the two ends of the arm of the device 10 are connected to the lock 16 so as to form a mechanically self-contained circuit and prevent removal of the object 14 from the motor vehicle 12.

By pushing the unlocking button 56 on the wireless remote control 52, the user effectuates an unlocking of the lock 16 of the device 10. At least one end of the arm connected to the lock 16 is decoupled from the lock 16, so that the mechanically self-contained circuit is interrupted, and the device 10 can generally be decoupled from the motor vehicle, that is, can be removed from the motor vehicle 12. Thereafter, the user can use the device 10, for example, at another location at the motor vehicle 12, for example from locking position A to locking position B, and/or for another object 14. The device 10 can thus be used in a multifaceted manner and is therefore especially user-friendly.

The button (not disclosed in greater detail for the purposes of brevity) of the wireless remote control 52 can be a separate button solely for locking or unlocking the device 10. In other words, it is possible, by operating this button of the wireless remote control 52, to operate the device 10 individually, independently of the door lock systems of the motor vehicle that are connected to the central locking system 12. This, for example, prevents the vehicle doors from being locked or unlocked when the user only desires to lock or unlock the object 14 locked by way of the device 10. The user is thus prevented from (inadvertently) locking or unlocking the vehicle doors.

In some examples, this button can also be a conventional button for opening the tailgate of the motor vehicle 12. Since the motor vehicle 12, in the example shown in FIG. 1, is provided with the mount 18 for receiving the bicycle 14, whereby the opening of the tailgate may be problematic, the system 50 can be modified so that, in this situation, pushing the button for opening the tailgate effectuates a locking or an unlocking of the device 10. Alternatively, or additionally, a locking request or an unlocking request of the user can also be effectuated by a longer push of the button and/or consecutive multiple operations, for example, double or triple tapping of the locking button 54, the unlocking button 56, or the button of the wireless remote control 52 (not disclosed in greater detail).

### LIST OF REFERENCE SIGNS

10 device
12 motor vehicle
14 object
16 lock
18 arm
20 mount for receiving a bicycle
50 system
52 wireless remote control
54 locking button
56 unlocking button
A. B locking positions

1. A device for a motor vehicle for locking and/or unlocking an object, the device comprising:
a lock;
a communication unit configured to send and receive radio signals, wherein the communication unit is configured to receive a radio signal comprising a locking request or an unlocking request from a user of a central locking system of the motor vehicle, the radio signal being received from a vehicle communication unit; and
a control unit configured to lock and/or unlock the lock based on the received radio signal,
wherein the device is configured to be couplable to the motor vehicle in a manner that allows variation in the position of the device with respect to the motor vehicle by locking of the lock.

2. The device of claim 1, wherein the device is configured to be decouplable from the motor vehicle by unlocking of the lock.

3. The device of claim 1, wherein the device is configured to be couplable to the motor vehicle in at least a plurality of locking positions, the plurality of locking positions comprising at least three different locking positions, at least five different locking positions, or a substantially continuous range of locking positions, by locking of the lock.

4. The device of claim 1, further comprising a mechanism for varying the coupling surface between the device and the motor vehicle and/or the object.

5. The device of claim 1, wherein the device is configured to be coupled to the motor vehicle so as to be movable with respect to the motor vehicle when the lock is in a locked state.

6. The device of claim 1, wherein the device is configured as a U-lock, a folding lock, a chain lock, a cable lock, or a textile lock.

7. The device of claim 1, wherein the communication unit is configured to send and receive UHF radio signals, and wherein the received radio signal is a UHF radio signal.

8. The device of claim 1, wherein the motor vehicle further comprises a mount configured to receive a bicycle, and wherein the device is configured as a bicycle lock or as a wheel boot.

9. A system for a motor vehicle for locking and/or unlocking an object, the system comprising:
a device, the device including:
a lock;
a communication unit configured to send and receive radio signals, wherein the communication unit is configured to receive a radio signal comprising a locking request or an unlocking request from a user of a central locking system of the motor vehicle, the radio signal being received from a vehicle communication unit; and
a control unit configured to lock and/or unlock the lock based on the received radio signal,
wherein the device is configured to be couplable to the motor vehicle in a manner that allows variation in the position of the device with respect to the motor vehicle by locking of the lock; and
a central locking system of the motor vehicle configured to be controlled by way of a wireless remote control.

10. The system of claim 9, wherein the wireless remote control comprises a separate function for locking and/or unlocking the device independently of the door lock systems of the motor vehicle connected to the central locking system.

11. The system of claim 9, wherein the device is configured to be decouplable from the motor vehicle by unlocking of the lock.

12. The system of claim 9, wherein the device is configured to be couplable to the motor vehicle in at least a plurality of locking positions, the plurality of locking positions comprising at least three different locking positions, at least five different locking positions, or a substantially continuous range of locking positions, by locking of the lock.

13. The system of claim 9, wherein the device further comprises a mechanism for varying the coupling surface between the device and the motor vehicle and/or the object.

14. The system of claim 9, wherein the device is configured to be coupled to the motor vehicle so as to be movable with respect to the motor vehicle when the lock is in a locked state.

15. The system of claim 9, wherein the device is configured as a U-lock, a folding lock, a chain lock, a cable lock, or a textile lock.

16. The system of claim 9, wherein the communication unit of the device is configured to send and receive UHF radio signals, and wherein the received radio signal is a UHF radio signal.

17. The system of claim 9, wherein the motor vehicle further comprises a mount configured to receive a bicycle, and wherein the device is configured as a bicycle lock or as a wheel boot.

18. A device for a motor vehicle for securing an object, the device comprising:
a lock;
a communication unit configured to send and receive radio signals, wherein the communication unit is configured to receive a radio signal from a vehicle communication unit, the radio signal comprising a command for securing or releasing the object;
a control unit configured to operate the lock based on the received radio signal; and
an adjustable coupling mechanism configured to mechanically connect the device to the motor vehicle at a plurality of selectable positions,
wherein the adjustable coupling mechanism comprises at least one arm that is configured to surround or engage an opening in the object and mechanically couple the object to the motor vehicle in a secured state.

19. The device of claim 18, wherein the adjustable coupling mechanism comprises releasable teeth configured to allow the arm to adjust its length, enabling the device to accommodate objects of varying dimensions.

20. The device of claim 18, wherein the communication unit is configured to send and receive ultra-high frequency (UHF) radio signals for wireless communication with the central locking system of the motor vehicle.
